(19) United States
(12) Patent Application Publication
(10) Pub. No.: US 2007/0030684 A1
(43) Pub. Date: Feb. 8, 2007

(54) Projecting apparatus and luminance adjusting method thereof

(75) Inventor: Sung-Wei Chan, Taoyuan City (TW)

Correspondence Address: RABIN & Berdo, PC, 1101 14TH STREET, NW, SUITE 500, WASHINGTON, DC, 20005, US

(73) Assignee: BenQ Corporation

(21) Appl. No.: 11/498,089

(22) Filed: Aug. 3, 2006

(30) Foreign Application Priority Data
Aug. 4, 2005 (TW) 94126623

(51) Int. Cl. F21V 5/00

(52) U.S. Cl. 362/333

(57) ABSTRACT

A projecting apparatus includes a lamp module, a reflection module, an image module, a projection module, a photo sensor and a control unit. The lamp module generates a beam of first light. The reflection module receives the beam of first light and reflecting a part of the first light to form a beam of second light. The other part of the first light passes through the reflection module to form a beam of third light. The image module generates a beam of fourth light according to the beam of second light. The projection module projects the beam of fourth light to form an image. The photo sensor senses intensity of the third light and outputs a sensing signal accordingly. The control unit outputs a control signal according to the sensing signal to control the lamp module to generate the first light.

This application claims the benefit of Taiwan application Serial No. 94126623, filed Aug. 4, 2005, the subject matter of which is incorporated herein by reference.

### BACKGROUND OF THE INVENTION

1. Field of the Invention

The invention relates in general to a projecting apparatus and luminance adjusting method thereof, and more particularly to a projecting apparatus where luminance of the lamp module can be automatically adjusted, and luminance adjusting method thereof.

2. Description of the Related Art

Due to the increasing popularity of projecting apparatus, no matter in offices or conference briefs, or in family theaters, the projecting apparatus play a very important role. Therefore, how to increase quality of the projecting apparatus has become an essential subject.

Referring to FIG. 1, a schematic diagram of a conventional projecting apparatus is shown. The projecting apparatus 100 includes a lamp module 110, a reflection module 120, an image module 150 and a projection module 160. The lamp module 100 is for generating a beam of light L by using a lamp for instance. The light L is reflected to the image module 150 by the reflection module 120. For example, the reflection module 120 is a mirror and the image module 150 is a digital micro-mirror device (DMD). The light L is projected to a screen 170 via the projection module 160 after passing the image module 150. The projection module 160 is a lens for instance.

However, the luminance of the projecting apparatus 100 is determined by the intensity of the light L generated by the lamp module 110. The luminance of the projecting apparatus 100 reduces as the lamp module 110 decays, thereby affecting the quality of the image projected onto the screen 170.

### SUMMARY OF THE INVENTION

It is therefore an object of the invention to provide a projecting apparatus and luminance adjusting method thereof. By sensing the light passing through the reflection module and accordingly controlling intensity of the light generated by the lamp module, the projecting apparatus can operate at a constant luminance.

The invention achieves the above-identified object by providing a projecting apparatus including a lamp module, a reflection module, a projection module, a photo sensor and a control unit. The lamp module is for generating a beam of first light. The reflection module is for receiving the beam of first light and reflecting a part of the first light to form a beam of second light. The other part of the first light passes through the reflection module to form a beam of third light. The projection module is for projecting the beam of second light to form an image. The photo sensor is for sensing intensity of the third light and outputting a sensing signal accordingly. The control unit is for outputting a control signal according to the sensing signal to control the lamp module to generate the first light.

The invention achieves the above-identified object by providing another projecting apparatus including a lamp, a mirror, a projection module, a photo sensor and a control unit. The lamp is for generating a beam of first light. The mirror is for receiving the beam of first light and reflecting a part of the first light to form a beam of second light. The other part of the first light passes through the mirror to form a beam of third light. The projection module is for projecting the beam of second light to form an image. The photo sensor is disposed at the rear of the mirror for outputting a sensing signal according to intensity of the third light. The control unit is for outputting a control signal according to the sensing signal to control the lamp module to generate the first light.

The invention achieves the above-identified object by providing a method for adjusting luminance of a projecting apparatus. The projecting apparatus includes a lamp module, a reflection module and a projection module. The lamp module generates a beam of light, and the reflection module reflects the beam of light. The method includes reflecting a part of the light by using the reflection module, wherein the projecting module projects the reflected part of the light to form an image; sensing the other part of the light passing through the reflection module, and generating a sensing signal; and controlling the lamp module to generate the light accordingly to the sensing signal.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of a conventional projecting apparatus.

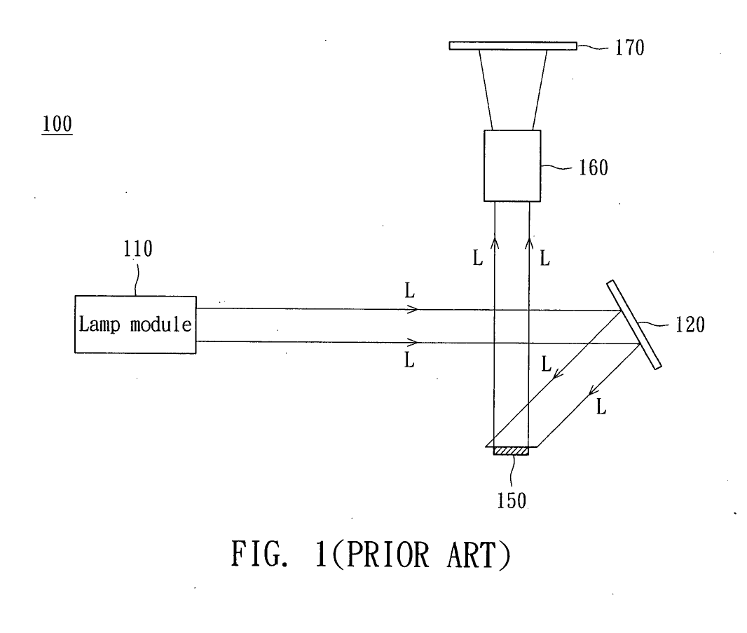

FIG. 2 is a schematic diagram of a projecting apparatus capable of automatically adjusting luminance.

FIG. 3 is a flow chart of the method for adjusting luminance of the projecting apparatus according to the preferred embodiment of the invention.

### DETAILED DESCRIPTION OF THE INVENTION

The projecting apparatus uses a lamp module as a light source to generate the light of expected intensity. The lamp module includes a lamp and ballast, and the ballast drives the lamp to generate the light of expected intensity. The luminance of the projecting apparatus is reduced as the lamp decays. Therefore, when the luminance of the lamp module is reduced due to lamp decay, the projecting apparatus can have better image quality if it can control the output power of the ballast such that its luminance can maintain at an ideal level according to luminance variation of the lamp module.

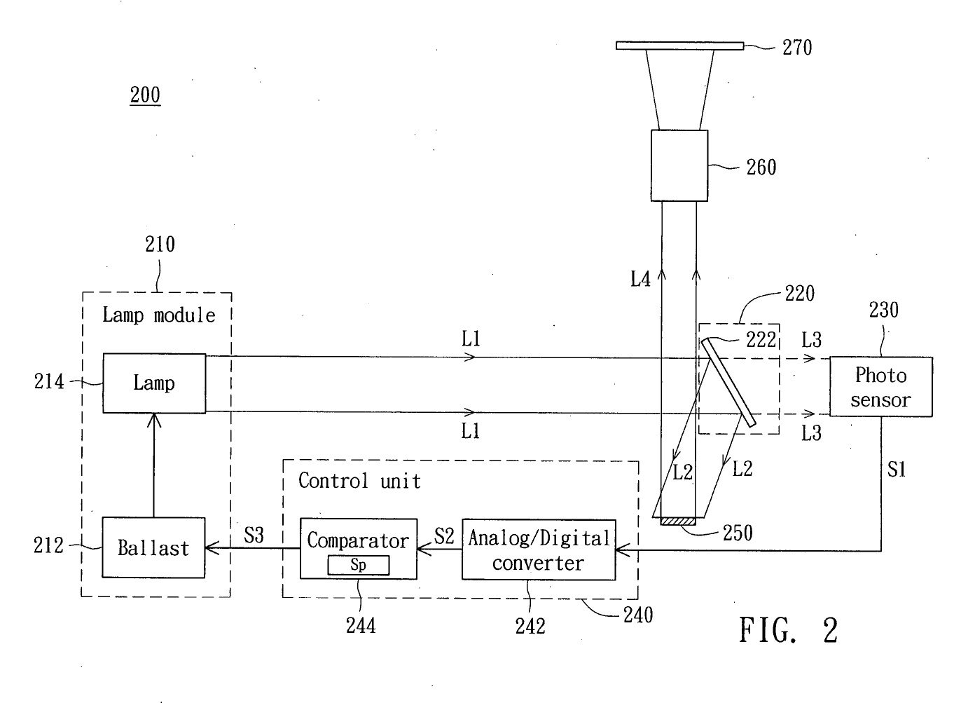

Referring to FIG. 2, a schematic diagram of a projecting apparatus capable of automatically adjusting luminance is shown. The projecting apparatus 200 includes a lamp module 210, a reflection module 220, a photo sensor 230, a control unit 240, an image module 250 and a projection module 260. The lamp module 210 generates a beam of first light L1. The reflection module 220 receives the beam of first light L1 and reflects a part of the first light L1 to form a beam of second light L2. The other part of the first light L1 passes through the reflection module 220 to form a beam of third light L3. The photo sensor 230 senses the luminance of the third light L3 and outputs a sensing signal S1 accordingly. The control unit 240 outputs a control signal S3 according to the sensing signal S1 to control the lamp module 210 to generate the first light L1 of constant intensity.

Furthermore, the lamp module 210 includes a ballast 212 and a lamp 214. The ballast 212 drives the lamp 214 to radiate the beam of first light L1. The reflection module reflects a large part of the first light L1 and lets a small part of the first light L1 to pass through as shown in FIG. 2. The reflection module 220 includes a mirror 222. The reflection module 220 is not limited to using a mirror 222, and the projecting apparatus 200 can use a number of mirrors in accordance with the requirement of light-path design. The mirror 222 has a reflection rate 99.8% and a transparency 0.2% for instance. After the first light L1 reaches the mirror 222, most part of the first light L1 is reflected by the mirror 222 to form the second light L2. The second light L2 is reflected by the image module 250 to generate a beam of fourth light L4, and the projection module 260 projects the beam of fourth light L4 onto the screen 270 to form an image. The image module 250 is a DMD and the projection module 260 is a lens for instance.

After the first light L1 reaches the mirror 222, a small part of the first light L1 passes through the mirror 222 to form the third light L3. The projecting apparatus 200 is configured with a photo sensor 230 at the rear of the mirror 222 in order to prevent the luminance reduction due to decay of the lamp 214. If a number of mirrors 222 are used, the photo sensor 230 can selectively be disposed at the rear of one of the mirrors 222. The photo sensor 230 is for sensing the third light L3 and outputs a sensing signal S1 according to the intensity of the third light L3.

The control unit 240 includes an analog/digital converter 242 and a comparator 244. The analog/digital converter 242 converts the sensing signal S1 to a digital signal S2. The comparator 244 has a predetermined value Sp corresponding to the constant intensity of the first light L1 (or the constant luminance of the lamp module 210). The comparator 244 compares the digital signal S2 and the predetermined value Sp and accordingly outputs a control signal S3, such as a voltage signal, for controlling the lamp module 210 to maintain the constant luminance.

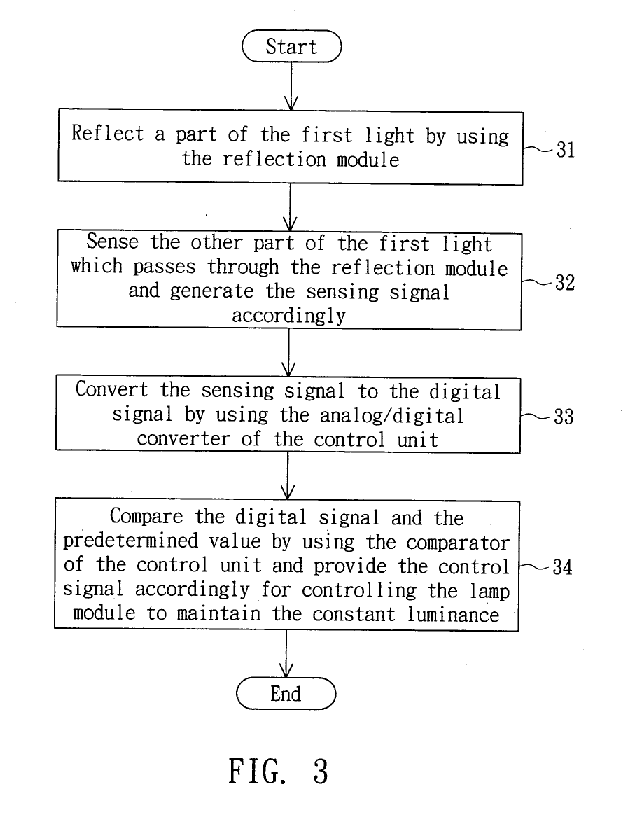

Referring to FIG. 3, a flow chart of the method for adjusting luminance of the projecting apparatus 200 according to the preferred embodiment of the invention is shown. As mentioned above, the lamp module 210 of the projecting apparatus 200 is for generating the first light L1. The method for adjusting luminance of the projecting apparatus 200 is illustrated as the following. First, in step 31, reflect a part of the first light L1 by using the reflection module 220 to form the second light L2, wherein the second light L2 is reflected by the image module 250 to generate the fourth light L4 and the fourth light L4 is projected to form an image by the projection module 260. Following that, in step 32, sense the other part of the first light L1, i.e. the third light L3, which passes through the reflection module 220 and generate the sensing signal S1 accordingly. Next, in step 33, convert the sensing signal S1 to the digital signal S2 by using the analog/digital converter 242 of the control unit 240. Finally, in step 34, compare the digital signal S2 and the predetermined value Sp by using the comparator 244 of the control unit 240 and provide the control signal S3 accordingly for controlling the lamp module 210 to maintain the constant luminance.

For example, firstly, the control unit 240 outputs the control signal S3 having a voltage 5V to control the ballast 212 to output an output power of 100 W, which is in turn for driving the lamp 214 to radiate the first light L1 of 1000 lumens (the constant luminance). When the lamp 214 of the lamp module 210 decays, the luminance of the first light L1 is reduced to only 800 lumens even though the ballast 212 outputs the same driving power. At the time, the control unit 240 can increase the output voltage to 6V and control the ballast 212 to output a driving power of 120 W according to a comparison result, such as the difference, of the digital signal S2 (corresponding to the sensing signal S1 of 800-lumen luminance) and the predetermined value Sp. If the adjusted luminance of the lamp 214 is still lower than 1000 lumens, the output voltage of the control unit 240 is continuously increased to 7V; if the adjusted luminance of the lamp 214 is higher than the predetermined 1000 lumens, the output voltage of the control unit 240 is reduced to 5.5V. By using the quadratic approximation method, the first light L1 generated by the lamp 214 can maintain to have the luminance of 1000 lumens. As a result, the projecting apparatus 200 can have better image performance.

The projecting apparatus and luminance adjusting method thereof disclosed by the above-mentioned embodiment of the invention have the following advantages. By using the photo sensor to sense intensity of the small part of the light passing through the mirror, the output power of the ballast can be adjusted such that the lamp module of the projecting apparatus can operate at constant luminance even when the lamp of the lamp module decays with time. Therefore, the lifetime of the projecting apparatus can be improved effectively.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A projecting apparatus, comprising:
a lamp module, for generating a beam of first light;
a reflection module, for receiving the beam of first light and reflecting a part of the first light to form a beam of second light, wherein the other part of the first light passes through the reflection module to form a beam of third light;
an image module, for generating a beam of fourth light according to the beam of second light;
a projection module, for projecting the beam of fourth light to form an image;
a photo sensor, for sensing intensity of the third light and outputting a sensing signal accordingly; and
a control unit, for outputting a control signal according to the sensing signal to control the lamp module to control the first light.

2. The projecting apparatus according to claim 1, wherein the control unit controls the lamp module to generate the first light of constant intensity.

3. The projecting apparatus according to claim 2, wherein the control unit comprises:
an analog/digital converter, for converting the sensing signal into a digital signal; and
a comparator, having a predetermined value corresponding to the constant intensity, wherein the comparator compares the digital signal and the predetermined value and outputs the control signal accordingly.

4. The projecting apparatus according to claim 1, wherein the reflection module comprises a mirror, and the beam of first light entering the reflection module passes through the mirror to form the beam of third light.

5. The projecting apparatus according to claim 4, wherein the reflection rate of the mirror is 99.8% and the transparency of the mirror is 0.2%.

6. The projecting apparatus according to claim 4, wherein the photo sensor is disposed at the rear of the mirror.

7. The projecting apparatus according to claim 1, is a front-light projector.

8. The projecting apparatus according to claim 1, is a backlight projecting TV.

9. A projecting apparatus, comprising:
a lamp, for generating a beam of first light;
a mirror, for receiving the beam of first light, and reflecting a part of the first light to form a beam of second light, wherein the other part of the first light passes through the mirror to form a beam of third light;
an image module, for generating a beam of fourth light according to the beam of second light;
a projection module, for projecting the beam of fourth light to form an image;
a photo sensor, disposed at the rear of the mirror, for outputting a sensing signal according to intensity of the third light; and
a control unit, for outputting a control signal according to the sensing signal to control the lamp module to control the first light.

10. The projecting apparatus according to claim 9, wherein the control unit controls the lamp module to generate the first light of constant intensity.

11. The projecting apparatus according to claim 10, wherein the control unit comprises:
an analog/digital converter, for converting the sensing signal into a digital signal; and
a comparator, having a predetermined value corresponding to the constant intensity, wherein the comparator compares the digital signal and the predetermined value and outputs the control signal accordingly.

12. The projecting apparatus according to claim 9, wherein the reflection rate of the mirror is 99.8% and the transparency of the mirror is 0.2%.

13. The projecting apparatus according to claim 9, is a front-light projector.

14. The projecting apparatus according to claim 9, is a backlight projecting TV.

15. A method for adjusting luminance of a projecting apparatus, the projecting apparatus comprising a lamp module, a reflection module, and an image module, the lamp module generating a beam of light, the reflection module reflecting the beam of light, the method comprising:
reflecting a part of the light to the image module by using the reflection module;
sensing the other part of the light passing through the reflection module, and generating a sensing signal; and
controlling the lamp module to generate the beam of light accordingly to the sensing signal.

16. The method according to claim 15, wherein the step of reflecting a part of the light to an image module by using the reflection module comprises reflecting 99.8% of the light by using the reflection module.

17. The method according to claim 15, wherein the step of controlling the lamp module comprises controlling the lamp module to generate the light of constant intensity accordingly to the sensing signal.

18. The method according to claim 17, wherein the step of controlling the lamp module comprises:
converting the sensing signal to a digital signal; and
comparing the digital signal and a predetermined value corresponding to the constant intensity and accordingly providing a control voltage to control the lamp module to generate the light of constant intensity.
